(19) United States
(12) Patent Application Publication
(10) Pub. No.: US 2005/0177529 A1
(43) Pub. Date: Aug. 11, 2005

(54) Risk management method

(76) Inventors: John Howard, Keller, TX (US); Dan M. Scott, Fort Worth, TX (US)

Correspondence Address: Steven Thrasher, 391 Sandhill Dr., Richardson, TX, 75080, US

(21) Appl. No.: 11/055,359

(22) Filed: Feb. 9, 2005

Related U.S. Application Data
(60) Provisional application No. 60/542,988, filed on Feb. 9, 2004.

(51) Int. Cl. G06F 15/18; G09G 5/00

(52) U.S. Cl. 706/1; 345/583

(57) ABSTRACT

The invention teaches evaluating geographical information, typically from at least two sources, and defining the nature of the information so that it can be applied to a risk management system. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CROSS REFERENCE TO RELATED APPLICATIONS

The invention is related to and claims priority from U.S. Provisional Patent Application No. 60/542,988, filed on 9 Feb. 2004, by Scott, et al., and entitled IMAGE ENHANCEMENTS.

### TECHNICAL FIELD OF THE INVENTION

The invention relates generally to geographic information systems, and more particularly to identifying objects in a geographic system.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Many industries rely on the accuracy of geographic information. The insurance industry, for example, charges flood insurance rates for a property based on the property's flood zone. Thus, if a property is identified incorrectly as being in a different flood zone, either the property's owner is paying too much, or the insurance company is not being compensated enough for the risk it is taking. Similarly, tax rates are dependent on municipality boundaries, and may vary widely from a non-incentived area to a tax-rate favored enterprise zone. Accordingly, if a property is identified incorrectly as being in the tax-favored enterprise zone, then the municipality's taxpayers are effectively subsidizing that business.

Improperly identifying the location of property can create other problems. Misidentifying school zones can impact class size, taxes, and property value, for example. Misidentifying property lines can impact value, zoning, insurance rates, and a host of other issues. Misidentifying a building location can result in inaccurate maps, and inaccurate driving directions, for example. Unfortunately, many geographic locations are not correctly identified. Accordingly, there is a need for systems, methods, and devices that provide meaningful information so that those who rely on accurate geographic information to manage the risk associated with the possibility of a misidentification of a geographic location.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 illustrates a flood zone map having a contradiction.

FIG. 2 shows a flood zone map having a second contradiction.

FIG. 3 is a flood zone map having an endangerment.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

Definitions

Attribute—a class or set name, which typically describes a polygon, to which values, including forms and characteristics, are assigned. Examples of attributes include: city, state, flood zone, average income, and tax area, for example.
Attribute Vector—a vector comprising a list of attributes. Attribute vectors are typically formed in preparation for evaluation of attribute values (see below).
Attribute-Value—a value an attribute may assume, including non-numeric values.
Attribute-Value Vector—A vector comprised of attribute values, arranged as defined in an associated attribute-vector.
Candidate Attribute Value Vector—an attribute value vector that is a speculative set of values, arranged as defined in an associated attribute vector, that may be tested and scored to determine accuracy or risk.
Polygon—a closed plane figure bounded by three or more line segments.
   Description of the Drawings
   General Discussion

One application of a Geographic Information System (GIS) is the reporting of attribute values for a geographic point or geographic area. Then, based on the reported attribute values, decisions are made regarding some course of action.

For example, assume there is an interest in the flood status of 123 Adams Street, Wickenburg, Ariz. 85390. The desire to determine the flood status of this property implies an interest in a certain set of flood related attributes (such as flood zone, flood map panel, and community), whose values must be determined for this specific property.

The process begins by geocoding the address, in a manner known in the art, to obtain coordinates such as longitude and latitude, describing a single representative geographic location, L. In other words, a single geographic point, L, represents the property that actually extends over some geographic area. This approximation creates the potential for some error, as attributes of the point location may or may not be representative of attributes associated with the entire area.

Next, polygons pertaining to the attributes of interest are identified and reported. Such polygons might include, for example, polygons delineating the boundaries of various cities such as the city of Wickenburg, polygons delineating the boundaries of FEMA flood maps, and polygons delineating the various flood zones depicted on the FEMA flood maps. Based on the polygons and their associated attributes, one may determine that the attribute values for L may be represented as a value vector, (X500, 04013C0255G, Wickenburg), where the three components refer to flood zone, flood map panel, and community respectively. The ability to fully and confidently derive the attribute value vector that presents the “answer” needed to report a flood status is dependent on several assumptions:
1. the attribute information described by the various polygons is not in any way contradictory or inconsistent;
2. the attribute information described by the various polygons is complete in the sense that a single attribute value vector can be determined for any given point (That is, there can be no ambiguity in the attribution of a location); and
3. the location, L, and all relevant polygons are specified with sufficient accuracy so that the attribute values may be determined with confidence.

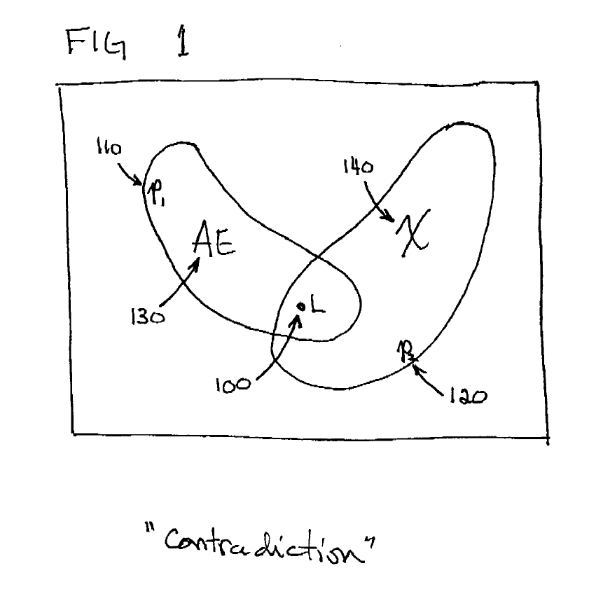

An example of a contradiction is shown in FIG. 1, where a location L is contained in two polygons, p1 and p2, where every point of the polygon p1 is asserted to have flood zone AE while every point of the polygon p2 is asserted to have flood zone X. Accordingly, at first glance, the proposition that location L has flood zone X appears just as risky as the proposition that location L has flood zone AE. However, this is not actually true since the financial consequences to a mortgage lending institution of asserting that a property is in zone X, when it is in fact in zone AE, are likely to be far more severe than the opposite assertion. This is because in the former case, the property would not normally have flood insurance and if the property actually flooded then the lender might be held liable for flood damage to the property.

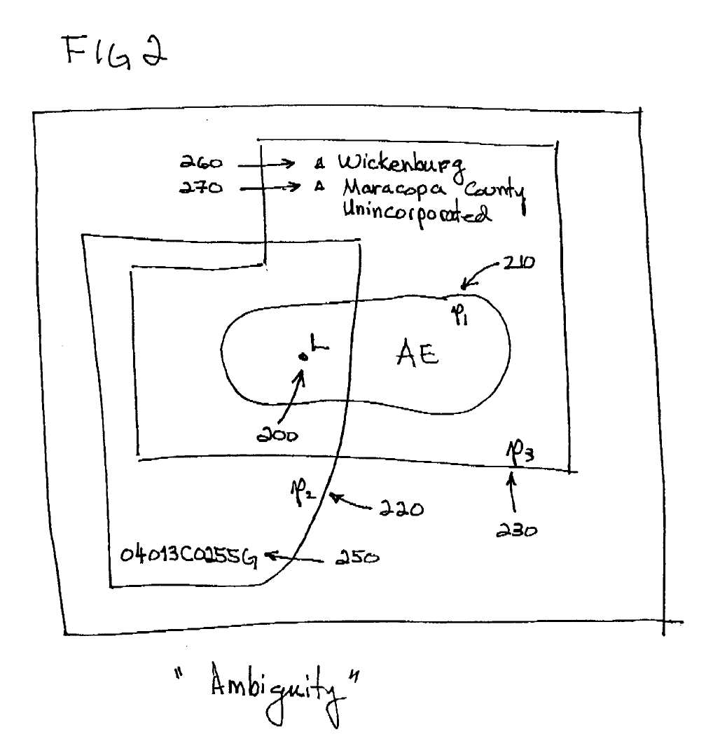

An example of an ambiguity is depicted in FIG. 2 where the point L is contained in exactly three polygons, p1, p2, and p3 (any other polygons are assumed, for purposes of illustration, to be irrelevant and are not shown), where every point of the polygon p1 is asserted to have flood zone AE while every point of the polygon p2 iis asserted to lie in flood map panel 04013C0255G, while every point of the polygon p3 is asserted to lie in either Wickenburg or Maricopa County Unincorporated Areas.

Based on this, the two possible attribute value vectors for location, L are: (AE, 04013C0255G, Wickenburg) and (AE, 04013C0255G, Maricopa County Unincorporated Areas). Thus the answer is ambiguous. As before, the selection of one of these possible attribute value vectors may not carry the same risk as selection of the other, since, for example, the National Flood Insurance Program (NFIP) participation status of the Wickenburg may not be the same as that for Maricopa County Unincorporated Areas.

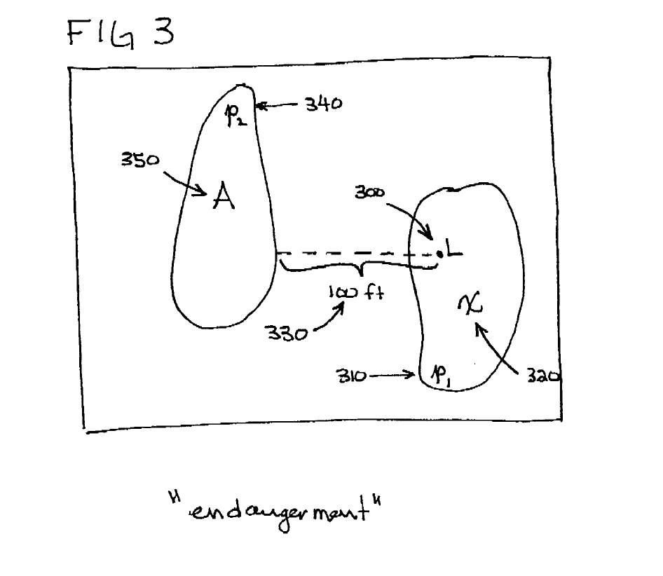

An example of endangerment is depicted in FIG. 3 where the point L is contained in one polygon p1 where every point of the polygon p1 is asserted to have flood zone X, and L lies just 100 feet outside of another polygon p2, where every point of the polygon p2 is asserted to have flood zone A and any other polygons are assumed, for purposes of illustration, to be irrelevant and are not shown. Then, on the basis of this information, it would necessarily be inferred that location L has a flood zone of X. However, if there is any inaccuracy in either the geocoding of the address (that determined L) or in the boundary definitions of the polygons p1 and p2 then it is possible that the inference that L has flood zone, X might be in error. In essence, the nearness of the A zone polygon p2 endangers our presumption that the correct flood zone is X. We may speak of the polygon p2 creating an endangerment for the presumption that L has flood zone X.

Extant GIS decision systems go to some lengths to avoid data contradictions or ambiguities. They make frequent use of “coverage data” in which a geographic region is partitioned into separate polygonal regions, each of which is assigned a complete set of attributes of interest. If such a coverage is somehow created, then any location within the coverage belongs to a single polygon whose attribute values will uniquely determine the attribute values for the location. However, such coverage data does not always exist, and its creation can be problematic. It is common to have more than one source of polygons and associated attribution information where the different sources disagree on the attribution of certain locations. For example, FEMA's Q3 polygon data might indicate that a particular location is in Dallas Tex., while polygons distributed by the U.S. Census Bureau might indicate that the exact same location is in the city of Irving Tex. On the other hand, data actually available may simply be incomplete, thus leading to ambiguities. Such situations are difficult to avoid entirely.

Even when contradictions and ambiguities are not a concern, it is not possible to completely avoid the possibility of endangerments, since some degree of inaccuracy in geocoding and/or polygon boundary definition is always a possibility. Extant GIS decision systems, if they consider this difficulty, will generally deal with it by specifying some buffer distances whereby locations and polygons that fail a buffer distance test may be flagged for human consideration outside of the automated GIS decision system. An example of such a buffer rule might be: If the flood zone is endangered by a different flood zone within 200 feet of the location, then refer this location to a human for manual processing.

While useful, such a simplistic buffer rule does not account for the essential fact that certain types of attribution errors carry inherently higher levels of risk than others. In the example described here, the consequences of designating a flood zone as X if it is actually A can be severe, since a substantial financial liability may be incurred as a result. In contrast, the consequences of designating a location as flood zone X if it is actually flood zone C are of little practical consequence—such an error carries little risk.

The invention described herein explains how to structure a GIS decision system in the face of polygon data that can give rise to any contradictions, endangerments, or ambiguities.

Evaluating the Risk for a Candidate Attribute Value Vector

Assume a location, L, and a set of polygons, P. Assume further, that for each polygon, p, which is a member of P, a set of attribution value vectors denoted by, A(p). The meaning of the polygon, p, and its set of attribution value vectors, A(p) should be interpreted as an assertion that:
any location inside the polygon, p, must have an attribution value vector that is identical to one of the attribution value vectors contained in the set, A(p).
   Assume now, a specific attribution value vector, v, which is as a possible candidate for the correct attribution of location, L. For any polygon, p, in P, the appropriateness of the candidate, v, can be considered vis a vis the assertions derived from p and A(p). Several situations must be considered:
1. If L is in P, and if v is not in A(p), then the candidate, v, is said to be contradicted by p. Associated with this contradiction, there will be a risk factor that provides a measure of the degree of risk associated with assigning the candidate, v, as the attribution value vector for location L, in the face of the contrary assertions arising from p and A(p). In general, this risk factor will be some function of L, p, A(p) and v. The precise form of the function depends on the specific GIS decision application under consideration.
2. If L is not in P, and if v is not in A(p) then the candidate, v, is entirely consistent with the assertions derived from p and A(p). However, the candidate, v, is endangered by the assertions arising from p and A(p). There will be a risk factor associated with this endangerment. In general, this risk factor will be some function of L, p, A(p) and v. The precise form of the function depends on the specific GIS decision application under consideration.
3. If v is in A(p), then the candidate, v, is entirely consistent with the assertions derived from p and A(p). No risk factors arise.
   A little explanation may aid in the understanding of these sources of risk factors.

### EXAMPLE 1

Suppose that the polygon, p, defines the borders of the city of Dallas Tex. The set A(p) will consist of all possible attribution value vectors whose community component is equal to ‘Dallas Tex.’. If the location, L, is inside the polygon, p, and if the candidate, v, has a community component equal to ‘Irving Tex.’, then (1) indicates that this is a contradiction, and that a risk factor for this contradiction can be computed, whose value will depend in some way on L, p, A(p) and v. In the case of flood determinations, the risk factor might be defined more specifically, to be affected by the difference in NFIP participation status of the two communities and the distance from location L to the border of polygon p.

### EXAMPLE 2

Suppose, as in example 1, that the polygon, p, defines the borders of a flood polygon that surrounds an AE zone. Then the set A(p) will consist of all possible attribution value vectors whose flood zone component is equal to AE. If the location, L, is outside the polygon p and if the candidate v has a flood zone component equal to X, then (2) above indicates that the candidate v is endangered, and that a risk factor for this endangerment can be computed whose value will depend in some way on L, p, A(p) and v. In the case of flood determinations, the risk factor might be defined more specifically to be affected by the difference in the danger of flooding between the two flood zone types (X vs. A) and the distance from location L to the border of polygon p.

### EXAMPLE 3

Suppose as in example (1) above that the polygon p defines the borders of the city of Dallas Tex. The set A(p) will consist of all possible attribution value vectors whose community component is equal to Dallas Tex. Further suppose that the candidate v has a community component equal to Dallas Tex. According to (3) there are no risk factors in this situation. This is intuitively obvious if the location L is inside the polygon p. However, if the location L is outside of the polygon p then this may appear to conflict with common sense. “If the location is outside of the borders of Dallas, then how can the candidate say L is in Dallas, and yet have no contradiction?” The answer to this is that a properly chosen set of polygons P will also include a polygon p′ which is the complement of p (i.e. p′ defines all areas outside of Dallas) whose set A(p′) consists of all possible attribute value vectors that have a community component different from Dallas Tex. The contradiction that one might intuitively expect will arise from the consideration of p′ and A(p′) rather than p and A(p).

Application

Risk factors may be represented in many possible forms. The precise GIS decision application may suggest possible forms for the risk factors. One might, for example, wish to represent a risk factor as a simple numerical value. Another possibility might be to represent a risk factor as a list of several items, for example (severe risk, 125 feet away).

For a given candidate v it is possible to determine the risk factors arising from each polygon, p in P. When multiple candidates can be found, none of which have risk factors arising from contradictions, then ambiguity is said to exist. To put this another way, when there is ambiguity, there are multiple distinct candidates whose attribute vector values are consistent with all of the polygons p in P and their sets A(p). The act of selecting a specific one of these “non-contradicted” candidates is seen to be, in itself, a risky action, since a wrong choice may have undesirable consequences. Ambiguities, then also give rise to risk factors. These risk factors in general depend on the precise candidates contained in the set of non-contradicted candidates.

From the risk factors, including contradictions, endangerments, and ambiguities, a risk summary can be determined. We may denote the risk summary for candidate, v, by r(v). Based on these risk summaries, a subset of the candidates considered, may be selected, and returned to a user of the system (or to another computer system interacting with this one) along with the corresponding risk summary information. In some cases, this subset may consist of a single candidate that is considered to have the lowest risk, while in other cases more than one candidate may be returned leaving the user (or other computer system) to decide what further actions should be taken.

Attributing Regions

Earlier, it was mentioned that determining the attribute value vector for a specific location L may be only an approximation to the real GIS decision problem, which may be to assign an attribute value vector to some region R. The ideas related above that apply to the location L may be readily adapted to problems calling for a risk analysis of possible attribution value vector candidates, v for a region R. In this case the risk factors for contradiction and endangerment will depend in some way on R, p, A(p) and v, while the risk factors for ambiguities will depend, as before on the specific set of non-contradicted candidate vectors.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

1. A method of assessing risk in a Graphical Information System (GIS), comprising:
designating
a set P that comprises at least one polygon,
a polygon in P as p,
a location as L,
the set of attribute value vectors interior to each polygon as A(p), and
a set of candidate value vectors for L as U, such that U comprises at least one candidate attribute value vector;
receiving P;
receiving a set of attribute value vectors for points interior to each polygon;
receiving the location, L;
determining U for a location designated as L;
evaluating at least one risk factor for an attribute value vector in U, for each p;
calculating a risk summary representing an aggregate risk for P;
selecting a subset of U based on the risk summary, the subset of U comprising candidate value vectors; and
returning an attribute value vector for each selected candidate value vector in the subset of U.

2. The method of claim 1 wherein a subset of U is selected based on the risk summary, the subset of U comprising candidate value vectors.

3. The method of claim 2 further comprising returning a risk summary for each selected candidate value vector in the subset of U.

4. The method of claim 1 wherein the attribute value vectors originate from a GIS data source.

5. The method of claim 1 wherein at least one attribute is duplicative.

6. The method of claim 1 wherein at least one attribute is incomplete.

7. The method of claim 1 wherein at least one attribute is contradictory.

8. The method of claim 1 wherein the received location L is generated by a user request.

9. The method of claim 1 wherein the received location L is generated by a computing device.

10. The method of claim 1 wherein the risk summary is a single numerical score.

11. The method of claim 1 wherein a contradiction exists when a candidate vector value is inconsistent with the definition of the polygon, p, and its associated set A(p).

12. The method of claim 1 wherein an ambiguity exists when more than one candidate vector value has no contradiction.

13. The method of claim I wherein an endangerment exists when a candidate vector value is inconsistent with any attribute vector values for any location sufficiently near to the received location L.

15. The method of claim 2 wherein the risk factors are calculated as a function of, L, p, A(p), A(p,out), and the candidate attribute value vector of U.

16. The method of claim 1 wherein the risk summary is a list of at least one risk factor.

17. The method of claim 1 wherein a single candidate attribute value vector is returned with risk summary information.

18. A method of assessing risk in a Graphical Information System (GIS), comprising:
designating
a set P that comprises at least one polygon,
a polygon in P as p,
a region as R,
the set of attribute value vectors interior to each polygon as A(p), and
a set of candidate value vectors as U, such that U comprises at least one candidate attribute value vector;
receiving P;
receiving a set of attribute value vectors for points interior to each polygon;
determining U for R;
evaluating at least one risk factor for an attribute value vector in U, for each p;
calculating a risk summary representing an aggregate risk for P;
selecting a subset of U based on the risk summary, the subset of U comprising candidate value vectors; and
returning an attribute value vector for each selected candidate value vector in the subset of U.

19. The method of claim 1 wherein a contradiction exists when a candidate vector value is inconsistent with the definition of the polygon, p, and its associated set A(p).

20. The method of claim 1 wherein an endangerment exists when a candidate vector value is inconsistent with any attribute vector values for any location sufficiently near to the received location L.
